(19) United States
(12) Patent Application Publication
(10) Pub. No.: US 2022/0171529 A1
(43) Pub. Date: Jun. 2, 2022

(54) INFORMATION PROCESSING METHOD, DEVICE, ELECTRONIC APPARATUS, AND STORAGE MEDIUM

(71) Applicant: Lenovo (Beijing) Limited, Beijing (CN)

(72) Inventor: Shiqi HUI, Beijing (CN)

(21) Appl. No.: 17/473,303

(22) Filed: Sep. 13, 2021

(30) Foreign Application Priority Data
Nov. 30, 2020 (CN) 202011380174.7

(51) Int. Cl. G06F 3/0488; G06F 3/0481

(52) U.S. Cl. CPC G06F 3/04886; G06F 2203/04803; G06F 3/0481

(57) ABSTRACT

An information processing method includes obtaining an information input instruction, in response to the information input instruction, obtaining attitude information of an electronic apparatus, and in response to the attitude information indicating that the electronic apparatus is in a landscape display mode, displaying a virtual keyboard in a first area of a display screen of the electronic apparatus. The first area corresponds to a short side of a display output area of the display screen, and the first area includes a part of the display output area of the display screen.

### CROSS-REFERENCE TO RELATED APPLICATION

This application claims priority to Chinese Patent Application No. 202011380174.7, filed on Nov. 30, 2020, the entire content of which is incorporated herein by reference.

### TECHNICAL FIELD

The present disclosure generally relates to the information processing technology field and, more particularly, to an information processing method, a device, an electronic apparatus, and a storage medium.

### BACKGROUND

Currently, an overall design of a portable electronic apparatus (such as a smartphone, etc.) is rectangular. Such an electronic apparatus provides a landscape display mode and a portrait display mode according to different attitudes of the electronic apparatus. When the electronic apparatus is in the landscape display mode, if the user is in an input scenario, a virtual keyboard interface occupies about two-thirds of the screen area. Thus, the user has a very small space that can be viewed, which significantly impacts the reading and viewing experience of the user.

### SUMMARY

Embodiments of the present disclosure provide an information processing method. The method includes obtaining an information input instruction, in response to the information input instruction, obtaining attitude information of an electronic apparatus, and in response to the attitude information indicating that the electronic apparatus is in a landscape display mode, displaying a virtual keyboard in a first area of a display screen of the electronic apparatus. The first area corresponds to a short side of a display output area of the display screen, and the first area includes a part of the display output area of the display screen.

Embodiments of the present disclosure provide an information processing device, including a first acquisition module, a second acquisition module, and a display module. The first acquisition module is configured to obtain an information input instruction. The second acquisition module is configured to, in response to the information input instruction, obtain attitude information of an electronic apparatus. The display module is configured to, in response to the attitude information indicating that the electronic apparatus is in a landscape display mode, display a virtual keyboard in a first area of a display screen of the electronic apparatus. The first area corresponds to a short side of a display output area of the display screen, and the first area includes a part of the display output area of the display screen.

Embodiments of the present disclosure provide an electronic apparatus, including a processor and a memory. The memory stores a program that, when executed by the processor, causes the processor to obtain an information input instruction, in response to the information input instruction, obtain attitude information of an electronic apparatus, and in response to the attitude information indicating that the electronic apparatus is in a landscape display mode, display a virtual keyboard in a first area of a display screen of the electronic apparatus. The first area corresponds to a short side of a display output area of the display screen, and the first area includes a part of the display output area of the display screen.

### BRIEF DESCRIPTION OF THE DRAWINGS

The following drawings are briefly described to make embodiments of the present disclosure clearer. The following drawings are merely some examples of the present disclosure. For those of ordinary skill in the art, other drawings may be obtained based on these drawings without creative work.

FIG. 1 illustrates a schematic diagram showing a display mode of a virtual keyboard when an electronic apparatus is in a landscape display mode according to some embodiments of the present disclosure.

FIG. 2 illustrates a schematic flowchart of an information processing method according to some embodiments of the present disclosure.

FIG. 3 illustrates a schematic diagram showing a display mode of a virtual keyboard when an electronic apparatus is in a horizontal display according to some embodiments of the present disclosure.

FIG. 4 illustrates a schematic flowchart showing a second area of an adapted display screen displaying a second target interface of a first application according to some embodiments of the present disclosure.

FIG. 5 illustrates a schematic flowchart showing displaying a virtual keyboard in a first area of the display screen of the electronic apparatus according to some embodiments of the present disclosure.

FIG. 6 illustrates a schematic structural diagram of an information processing device according to some embodiments of the present disclosure.

FIG. 7 illustrates a schematic structural diagram of the electronic apparatus according to some embodiments of the present disclosure.

### DETAILED DESCRIPTION OF THE EMBODIMENTS

The technical solution of the present disclosure is described in detail in connection with the accompanying drawings of embodiments of the present disclosure. The described embodiments are only some embodiments, not all embodiments of the present disclosure. Based on embodiments of the disclosure, all other embodiments obtained by those of ordinary skill in the art without any creative work are within the scope of the present disclosure.

In the specification, the claims, and the accompanying drawings of the present disclosure, the terms “first,” “second,” “third,” “fourth,” etc. (if any) are configured to distinguish similar parts and are not necessarily used to describe specific order or sequence. The data described in this way may be interchangeable under an appropriate circumstance. Thus, embodiments of the present disclosure may be implemented in a sequence other than those illustrated here.

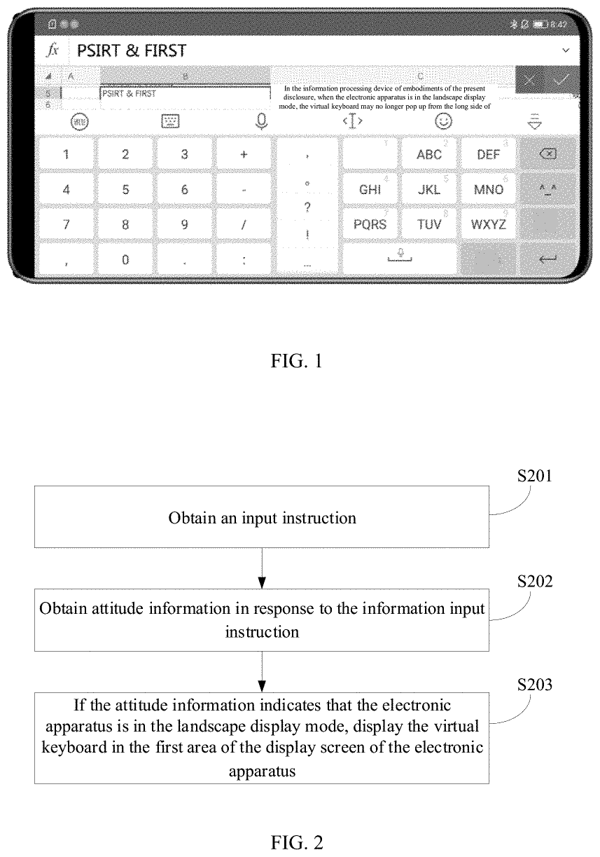

FIG. 1 illustrates a schematic diagram showing a display mode of a virtual keyboard when an electronic apparatus is in a landscape display mode in the prior art. As shown in FIG. 1, the virtual keyboard pops up from a long side of the electronic apparatus. The virtual keyboard occupies most of a screen area. Thus, the user may have a very small readable space. Moreover, since virtual keys of the virtual keyboard are distributed along the entire long side of the electronic apparatus, the user can only input information with both hands, which is not convenient for the user to operate.

To at least partially solve the above technical issue, embodiments of the present disclosure provide a solution of the present disclosure.

FIG. 2 illustrates a schematic flowchart of an information processing method according to some embodiments of the present disclosure. The information processing method includes the following steps.

At S201, the electronic apparatus obtains an input instruction.

When the user wants to input information into the electronic apparatus, the user may perform a preset operation so that the electronic apparatus may obtain the input instruction. For example, when a display interface includes an information input window, the user may click the information input window such that the electronic apparatus may obtain the information input instruction.

At S202, the electronic apparatus obtains attitude information in response to the information input instruction.

The electronic apparatus may obtain the attitude information of the electronic apparatus based on a sensing device in the electronic apparatus. The sensing device may include but is not limited to, a gravity sensor.

At S203, if the attitude information indicates that the electronic apparatus is in the landscape display mode, the electronic apparatus displays the virtual keyboard in the first area of the display screen of the electronic apparatus.

The first area may correspond to a short side of the display output area of the display screen. The first area may include a part of the display output area of the display screen.

If the attitude information indicates that the electronic apparatus is in a landscape attitude (as shown in FIG. 1), the attitude information may indicate that the electronic apparatus is in a landscape display mode. If the attitude information indicates that the electronic apparatus is in a portrait attitude (an attitude of the electronic apparatus shown in FIG. 1 after being rotated 90° counterclockwise or clockwise), the attitude information may indicate that the electronic apparatus is in a portrait display mode.

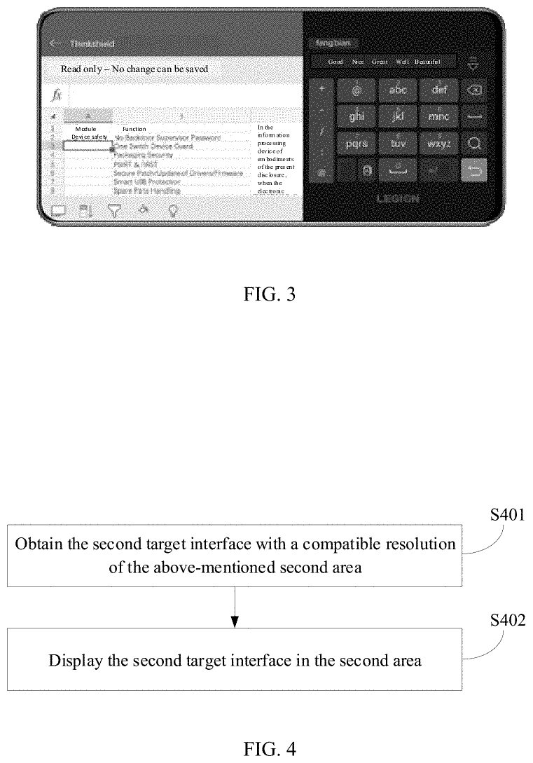

FIG. 3 illustrates a schematic diagram showing a display mode of a virtual keyboard when an electronic apparatus is in a horizontal display according to some embodiments of the present disclosure.

In some embodiments, when the electronic apparatus is in the landscape display mode, the virtual keyboard may no longer pop out from the long side of the electronic apparatus. Instead, the virtual keyboard may pop out from a short side of the electronic apparatus. The virtual keyboard may be merely displayed in the first area where the short side of the electronic apparatus matches and may be no longer distributed along the long side of the electronic apparatus. Thus, the visible area of the landscape screen input scene may be increased. The problem that the virtual keyboard interface in the horizontal screen input scenario occupies most of the screen area, the readable space of the user becomes very small, and the reading experience is significantly impacted may be overcome. In addition, the virtual keyboard locates on the short side of the screen. Thus, the user may perform an operation with a single hand in the landscape input scene. The use of the electronic apparatus in the portrait input scene may become easier.

In some embodiments, when the electronic apparatus is in the landscape display mode, the electronic apparatus may display a first target interface of a first application. Thus, the first target interface is displayed in the display output area of the display screen of the electronic apparatus in the landscape display mode. The first application may include any application in the electronic apparatus.

In some embodiments, the first target interface of the first application may be displayed based on the display output area of the adapted display screen. In some embodiments, the virtual keyboard may be displayed in the first area. The virtual keyboard may cover the first portion of the first area where the first target interface is located.

In some embodiments, when the virtual keyboard needs to be displayed, the first target interface may still include the display output area of the display screen. The first portion of the first target interface and the virtual keyboard may be output through the first area. Since the virtual keyboard covers the top of the first portion of the first target interface, the user may only see a second portion of the first target interface. The first portion and the second portion of the first target interface may constitute the first target interface.

The first target interface of the first application may be output and displayed application, and the first target interface is displayed based on the adapted display output area. In some embodiments, the virtual keyboard may be displayed in the first area. A second target interface of the first application may be displayed in the second area in the adapted landscape display mode. The second target interface is different from the first target interface. The first area and the second area constitute the output display area of the display screen.

In some embodiments, the first target interface of the first application may not be displayed in the output display area of the adaptable display screen. Instead, the output interface of the first application may be displayed in a part of the adapted display screen (the second area). In some embodiments, the first area of the display screen may merely output a virtual keyboard, and the output interface of the first application may merely be outputted in the second area of the display screen.

In some embodiments, FIG. 4 illustrates a schematic flowchart showing the second area of an adapted display screen displaying a second target interface of a first application according to some embodiments of the present disclosure. The flowchart includes the following steps.

At S401, the electronic apparatus obtains the second target interface with a compatible resolution of the above-mentioned second area.

The resolution of the second area includes the pixel distribution of the second area of the display screen. For example, if the display resolution of the output area of the display screen is 2400×1080, the display output area of the display screen is in the direction parallel to the long side. Each row of the display screen includes 2400 pixels. In the direction perpendicular to the long side, each column includes 1080 pixels. Since the second area includes a part of the display output area of the display screen, the display resolution of the second area may be less than the resolution of the display output area of the display screen. For example, the display resolution of the second area may be 1080×1080. The resolution may merely be exemplary and should not be a limitation to the present disclosure.

In some embodiment, obtaining the second target interface that is compatible with the display resolution may include obtaining a third target interface of the first application. The third target interface may include an interface of the display output area of the adapted display screen that is generated by the first application based on the portrait display mode of the electronic apparatus. The third target interface may be rotated and zoomed to obtain the second target interface. By rotating the third target interface, a display direction of characters in the third target interface may be parallel to the short side of the display output area of the display screen.

In some embodiments, obtaining the second target interface that matches the display resolution may include obtaining the second target interface that is generated by the first application and adapts to the display resolution. A difference of the present method compared to the former method may include that the second target interface may be generated by the first application automatically adapts the display resolution of the second area.

At S402, the electronic apparatus displays the second target interface in the second area.

In some embodiments, as shown in FIG. 5, the above-mentioned implementation flowchart of displaying the virtual keyboard in the first area of the display screen of the electronic apparatus is shown in FIG. 5. Displaying the virtual keyboard in the first area of the display screen may include the following steps.

At S501, the electronic apparatus obtains habit data of the user of the electronic apparatus.

The electronic apparatus may obtain the operation habit data of the user by statistical analysis of input operation data the user in the landscape display mode of the electronic apparatus. In some embodiments, each time when the user enters information through the virtual keyboard in the landscape display mode, the position of the virtual keyboard may be recorded. The position of the virtual keyboard may be either the target area of the first short side of the display screen or the target area of the second short side of the display screen. By counting a number of times the virtual keyboard is located at each position within the preset historical time period, the position with the largest number of times where the virtual keyboard is located may be determined as the operation habit data.

To better adapt to the operation habits of the user, historical data may be used to determine the operation habit data of the user periodically. Each time the operation habit data of the user is determined. If the determined operation habit data is different from the operation habit data determined in the previous cycle, then the determined operation habit data with the operation habit data may replace the determined habit data of the previous cycle. Otherwise, the operation habit data determined in the previous cycle may remain unchanged.

At S502, the electronic apparatus determines the first area based on the operation habit data of the user. If the operation habit data of the user includes the first target data, the target area on the first short side of the display screen is determined as the first area. If the operation habit data of the user includes second target data, the target area on the second short side of the display screen is determined as the first area.

If the operation habit data of the user includes the first target data, it means that the user is used to placing the virtual keyboard on the first short side of the display screen for operation. If the operation habit data of the user is the second target data, it means that the user is used to using the virtual keyboard on the second short side of the display for operation.

At S503, the electronic apparatus displays the virtual keyboard in the first area.

Further, the target area on the side of the first short side of the display screen is determined as the first area, and the virtual keyboard is displayed. If a switch instruction of the user for the display area of the virtual keyboard is received, the display area of the virtual keyboard may be switched to the target area on the second short side of the display screen. Similarly, the target area on the second short side of the display screen is determined as the first area, and the virtual keyboard is displayed. If the switch instruction of the user for the display area of the virtual keyboard is received, the display area of the virtual keyboard may be switched to the target area on the first short side of the display screen.

In some embodiment, an implementation manner of displaying the virtual keyboard in the first area of the display screen of the electronic apparatus may include the following steps.

The electronic apparatus may obtain a view of the virtual keyboard. The view of the virtual keyboard at least may include an input view (such as a view of the keyboard area) and a candidate word view. In addition to these two views, the view of the virtual keyboard may also include another view, such as a decorative view, which is not limited here.

The size of the view of the virtual keyboard may be adjusted according to the resolution of the first area to cause the view of the virtual keyboard to adapt to the first area.

The above two steps may be implemented by an input method application calling an input method service (InputMethodService).

The adjusted view of the virtual keyboard may be displayed in the first area to cause the display direction of the characters in the virtual keyboard to be parallel to the short side of the display screen. After the size of the view of the virtual keyboard is adjusted by the InputMethodService, the adjusted view of the virtual keyboard may be sent to a window management service (WindowManagerService). Alignment of the view of the virtual keyboard may be adjusted by the WindowManagementService, so that the display direction of the characters in the virtual keyboard may be parallel to the short side of the display screen.

In some embodiments, after displaying the virtual keyboard in the first area of the display screen of the electronic apparatus, the method may further include, if the electronic apparatus is switched from the landscape display mode to the portrait display mode, adjusting the display direction of the virtual keyboard in the first area. Thus, the display direction of the characters in the virtual keyboard is switched from parallel to the short side of the display output area of the display screen to perpendicular to the short side of the display output area of the display screen. By adjusting the display direction of the virtual keyboard, the virtual keyboard matches the portrait display mode of the electronic apparatus.

In some embodiments, adjusting the display direction of the virtual keyboard includes rotating the virtual keyboard in the first area. Thus, the display direction of the characters in the virtual keyboard may be switched from being parallel to the short side of the display output area of the display screen to being perpendicular to the short side of the display output area of the display screen. In some embodiments, by adjusting the display direction of the displayed virtual keyboard, the virtual keyboard may match the portrait display mode of the electronic apparatus. In some embodiments, after the virtual keyboard is rotated, the size of the virtual keyboard may be adjusted. Thus, the length of the first side of the virtual keyboard is the same as the length of the short side of the display output area. The first side may coincide with the short side of the display output area. The first side may include a side of the virtual keyboard parallel to the short side of the display output area.

In some embodiments, adjusting the display direction of the virtual keyboard includes stopping displaying the virtual keyboard, obtaining the view of the virtual keyboard, and adjusting the size of the view of the virtual keyboard according to the resolution of the first area. Thus, the view of the virtual keyboard adapts to the first area. Adjusting the display direction of the virtual keyboard further includes displaying the view of the virtual keyboard in the first area. Thus, the display direction of the characters of the virtual keyboard is perpendicular to the short side of the display screen.

In some embodiments, if the electronic apparatus is switched from the landscape display mode to the portrait display mode, the virtual keyboard may no longer be displayed in the landscape display mode. A virtual keyboard that matches the portrait display mode may be retrieved.

In some embodiments, after displaying the virtual keyboard in the first area of the display screen of the electronic apparatus, the method may further include, if the electronic apparatus is switched from the landscape display mode to the portrait display mode, adapting the display output area of the display screen to display a fourth target interface of the first application in the portrait display mode. The display direction of the characters in the fourth target interface may be perpendicular to the short side of the display output area of the display screen.

The fourth target interface may be obtained by rotating and zooming the second target interface.

In some embodiments, the fourth target interface may be generated by the first application to adapt to the display output area of the display screen in the portrait display mode.

In some embodiments, after displaying the virtual keyboard, the method further includes obtaining an interface browsing instruction. The interface browsing instruction may be triggered and generated by the user operating a preset button or may be generated by the user performing sliding up and down on the touch screen, which is not limited.

The method further includes, in response to the interface browsing instruction, stopping displaying the virtual keyboard and adapting the display output interface of the display screen to display a fifth target interface of the first application in the landscape display mode. In some other embodiments, the method further includes maintaining displaying the virtual keyboard and updating the display content of the first target interface or the second target interface. The content of the fifth target interface may be determined in response to updating the content of the first target interface or the second target interface.

In some embodiments, after displaying the virtual keyboard, the method further includes when inputting information through the virtual keyboard, displaying the input information and candidates corresponding to the input information in the first area and entering the selected candidate into an input window of the second area.

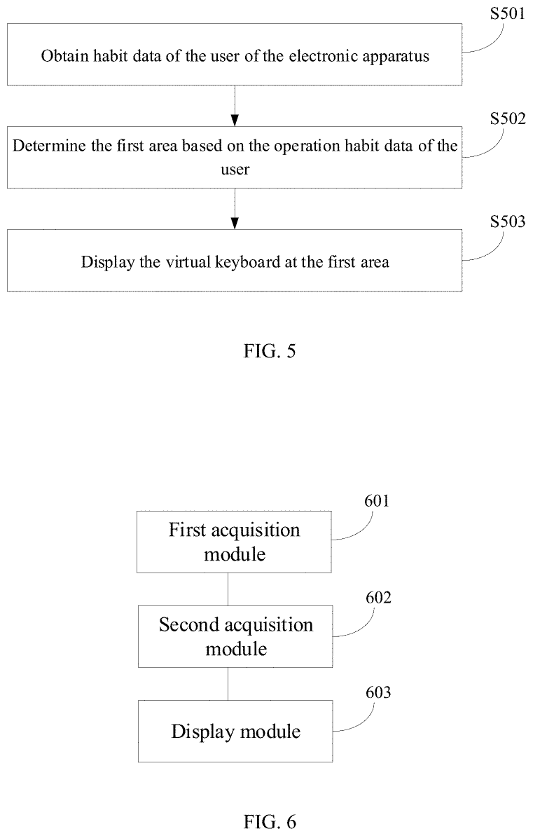

Corresponding to method embodiments, embodiments of the present disclosure also provide an information processing device. FIG. 6 illustrates a schematic structural diagram of an information processing device according to some embodiments of the present disclosure. the information processing device includes a first acquisition module 601, a second acquisition module 602, and a display module 603. The first obtaining module 601 may be configured to obtain an information input instruction. The second obtaining module 602 may be configured to obtain attitude information of the electronic apparatus in response to the information input instruction. The display module 603 may be configured to display a virtual keyboard in the first area of the display screen of the electronic apparatus if the attitude information indicates that the electronic apparatus is in the landscape display mode. The first area corresponds to the short side of the display output area of the display screen. The first area is a part of the display output area of the display screen.

In the information processing device of embodiments of the present disclosure, when the electronic apparatus is in the landscape display mode, the virtual keyboard may no longer pop up from the long side of the electronic apparatus, but the virtual keyboard may pop up from the short side of the electronic apparatus. The electronic apparatus may display the virtual keyboard only in the first area corresponding to the short side of the electronic apparatus. The virtual keyboard may not extend over the entire long side of the electronic apparatus. Thus, the area of the visible area may be increased in the landscape input scene. Thus, the problem that the virtual keyboard interface in the horizontal screen input scenario occupies most of the screen area, the readable space of the user becomes very small, and the reading experience is significantly impacted may be overcome. In addition, the virtual keyboard may be located on the short side of the screen, so that the user may perform the input operation with a single hand in the landscape input scene. The use of the electronic apparatus may become easier in the landscape input scene.

In some embodiments, the display module 603 may be configured to, if the electronic apparatus is in the landscape display mode, display the first target interface of the first application in the display output area by adapting to the landscape display mode, display the virtual keyboard in the first area. In some other embodiments, the display module 603 may be further configured to, when displaying the virtual keyboard in the first area, display the second target interface of the first application in the second area of the display screen by adapting to the landscape display mode. The virtual keyboard may cover the first portion of the first target interface that is located in the first area.

In some embodiments, when the electronic apparatus displays the second target interface of the first application by adapting to the second area of the display screen, the display module 603 may be configured to obtain the second target interface that matches the display resolution of the second area and display the second target interface in the second area.

In some embodiments, when the electronic apparatus displays the virtual keyboard in the first area of the display screen of the electronic apparatus, the display module 603 may be configured to obtain operation habit data of the user of the electronic apparatus, if the operating habit data is the first target data, determine the target area on the first short side of the display screen as the first area, if the operation habit data is the second target data, determine the target area on the second short side of the display screen as the first area, and display the virtual keyboard in the first area.

In some embodiments, when the electronic apparatus displays the virtual keyboard in the first area of the display screen of the electronic apparatus, the display module 603 may be configured to obtain the view of the virtual keyboard, adjust the size of the view of the virtual keyboard according to the resolution of the first area to cause the view of the virtual keyboard view to adapt to the first area, display the view of the virtual keyboard in the first area to cause the display direction of the characters of the virtual keyboard to be parallel to the short side of the display screen.

In some embodiments, the electronic apparatus displays the virtual keyboard in the first area of the display screen of the electronic apparatus. The display module 603 may be further configured to, if the electronic apparatus is switched from the landscape display mode to the portrait display mode, adjust the display direction of the virtual keyboard in the first area to cause the display direction of the characters of the virtual keyboard to be switched from being parallel to the short side of the display output area of the display screen to being perpendicular to the short side of the display output area of the display screen.

In some embodiments, the electronic apparatus adjusts the display direction of the virtual keyboard in the first area. The display module 603 may be configured to rotate the virtual keyboard in the first area to cause the display direction of characters in the virtual keyboard to be switched from being parallel to the short side of the display output area of the display screen to being perpendicular to the short side of the display output area of the display screen. In some other embodiments, the display module 603 may be configured to stop displaying the virtual keyboard, obtain the view of the virtual keyboard, and adjust the size of the view of the virtual keyboard according to the resolution of the first area to cause the view of the virtual keyboard to adapt to the first area. Then, display module 603 may be configured to display the view of the virtual keyboard in the first area to cause the display direction of the characters of the virtual keyboard to be perpendicular to the short side of the display output area of the display screen.

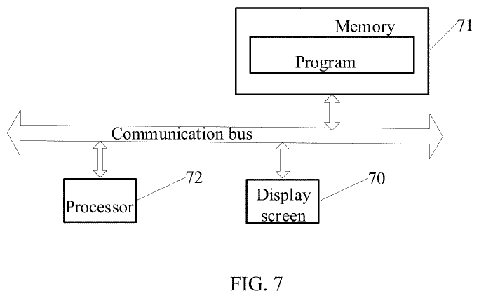

The present disclosure also provides an electronic apparatus corresponding to method embodiments. FIG. 7 illustrates a schematic structural diagram of the electronic apparatus according to some embodiments of the present disclosure. The electronic apparatus includes a display screen 70, a memory 71, and a processor 72. The display screen 70 may be configured to display information. The memory 71 may be configured to store a program. The processor 72 may be configured to call and execute the program in the memory to execute the instruction set to obtain an information input instruction, in response to the information input instruction, obtain attitude information of the electronic apparatus, and if the attitude information indicates that the electronic apparatus is in the landscape display mode, display the virtual keyboard in the first area of the display screen. The first area may correspond to the short side of the display output area of the display screen. The first area may include a part of the display output area of the display screen.

In some embodiments, for detailed functions and extended functions of the program, reference may be made to the above description.

Embodiments of the present disclosure further provide a storage medium. The storage medium may store a program suitable for a processor that, when executed by the processor, causes the processor to obtain an information input instruction, in response to the information input instruction, obtain attitude information of the electronic apparatus, and if the attitude information indicates that the electronic apparatus is in the landscape display mode, display the virtual keyboard in the first area of the display screen. The first area may correspond to the short side of the display output area of the display screen. The first area may include a part of the display output area of the display screen.

In some embodiments, for detailed functions and extended functions of the program, reference may be made to the above description.

Those of ordinary skill in the art may be aware that the units and algorithm steps of the examples described in embodiments of the present disclosure may be implemented by electronic hardware or a combination of computer software and electronic hardware. Whether these functions are executed by hardware or software depends on the specific application and design constraint conditions of the technical solution. Those of skill in the art may.3 use different methods for each specific application to implement the described functions, but such implementation should not be considered beyond the scope of the present disclosure.

In the several embodiments of the present disclosure, the disclosed system, device, and method may be implemented in another method. In addition, the displayed or discussed mutual coupling or direct coupling or communication connection may include indirect coupling or communication connection through some interfaces, devices, or units. The displayed or discussed mutual coupling or direct coupling or communication connection and may be electrical, mechanical, or in another form.

The units described as separate components may or may not be physically separated, and the components displayed as units may or may not be physical units. That is, the units may be located in one place or distributed on multiple network units. Some or all of the units may be selected according to actual needs to achieve the purpose of the solutions of embodiments of the present disclosure.

In addition, the functional units in various embodiments of the present disclosure may be integrated into one processing unit, or each unit may exist individually and physically, or two or more units may be integrated into one unit.

In embodiments of the present disclosure, the dependent claims, various embodiments, and features may be combined with each other to solve the above-described technical problem.

If the function is implemented in the form of a software functional unit and sold or used as an independent product, the software functional unit may be stored in a computer readable storage medium. Thus, the technical solution of the present disclosure essentially or the part of the technical solution that contributes to the existing technology or the part of the technical solution may be embodied in the form of a software product. The computer software product may be stored in a storage medium, including several instructions that are used to cause a computer device (which may be a personal computer, a server, or a network device, etc.) to execute all or part of the steps of the methods described in various embodiments of the present disclosure. The storage medium may include media that can store the program codes, such as a U disk, a mobile hard disk, a read-only memory (ROM), a random access memory (RAM), a magnetic disk, or an optical disk, etc.

The description of embodiments of the present disclosure enables those skilled in the art to implement or use the present disclosure. Various modifications to embodiments of the present disclosure are obvious to those skilled in the art. The general principles defined in the specification may be implemented in other embodiments without departing from the spirit or scope of the present disclosure. Therefore, the present disclosure is not limited to the embodiments shown in the specification but should conform to the widest scope consistent with the principles and novel features disclosed in the specification.

What is claimed is:

1. An information processing method, comprising:
obtaining an information input instruction;
in response to the information input instruction, obtaining attitude information of an electronic apparatus; and
in response to the attitude information indicating that the electronic apparatus is in a landscape display mode, displaying a virtual keyboard in a first area of a display screen of the electronic apparatus;
wherein the first area corresponds to a short side of a display output area of the display screen, and the first area includes a part of the display output area of the display screen.

2. The method of claim 1, wherein displaying the virtual keyboard in the first area of the display screen of the electronic apparatus includes:
in response to the electronic apparatus being in the landscape display mode, displaying a first target interface of a first application in the display output area adapting to the landscape display mode;
displaying the virtual keyboard in the first area, the virtual keyboard covering a first portion of the first target interface located in the first area; or
when displaying the virtual keyboard in the first area, displaying a second target interface of the first application in a second area of the display screen adapting to the landscape display mode.

3. The method of claim 2, wherein displaying the second target interface of the first application in the second area of the display screen adapting to the landscape display mode includes:
obtaining the second target interface matching display resolution of the second area; and
displaying the second target interface in the second area.

4. The method of claim 1, wherein displaying the virtual keyboard in the first area of the display screen of the electronic apparatus includes:
obtaining operation habit data of a user of the electronic apparatus;
in response to the operation habit data being first target data, determining a target area of a first short side of the display screen as the first area;
in response to the operation habit date being second target data, determining a target area of a second short side of the display screen as the first area; and
displaying the virtual keyboard in the first area.

5. The method of claim 1, wherein displaying the virtual keyboard in the first area of the display screen of the electronic apparatus includes:
obtaining a view of the virtual keyboard;
adjusting a size of the view of the virtual keyboard according to a resolution of the first area to cause the view of the virtual keyboard to adapt to the first area; and
displaying the view of the virtual keyboard in the first area, a display direction of characters in the virtual keyboard being parallel to a short side of the display screen.

6. The method of claim 1, further comprising, after displaying the virtual keyboard in the first area of the display screen of the electronic apparatus:
in response to the electronic apparatus being switched from the landscape display mode to a portrait display mode, adjusting a display direction of the virtual keyboard in the first area so that a display direction of characters in the virtual keyboard are switched from being parallel to the short side of the display output area of the display screen to being perpendicular to the short side of the display output area of the display screen.

7. The method of claim 6, wherein adjusting the display direction of the virtual keyboard in the first area includes:
rotating the virtual keyboard in the first area to cause the display direction of the characters in the virtual keyboard to be switched from being parallel to the short side of the display output area of the display screen to being perpendicular to the short side of the display output area of the display screen; or
stopping displaying the virtual keyboard;
obtaining the view of the virtual keyboard;
adjusting a size of the view of the virtual keyboard according to a resolution of the first area to cause the view of the virtual keyboard to adapt to the first area; and
displaying the view of the virtual keyboard in the first area to cause the display direction of the characters in the virtual keyboard to be perpendicular to the short side of the display output area of the display screen.

8. An information processing device, comprising:
a first acquisition module configured to obtain an information input instruction;
a second acquisition module configured to, obtain attitude information of an electronic apparatus in response to the information input instruction; and
a display module configured to display a virtual keyboard in a first area of a display screen of the electronic apparatus, in response to the attitude information indicating that the electronic apparatus is in a landscape display mode;
wherein the first area corresponds to a short side of a display output area of the display screen, and the first area includes a part of the display output area of the display screen.

9. The device of claim 8, wherein the display module is further configured to:
in response to the electronic apparatus being in the landscape display mode, display a first target interface of a first application in the display output area adapting to the landscape display mode;
display the virtual keyboard in the first area, the virtual keyboard covering a first portion of the first target interface located in the first area; or
when the virtual keyboard is displayed in the first area, display a second target interface of the first application in a second area of the display screen adapting to the landscape display mode.

10. The device of claim 9, wherein the display module is further configured to:
obtain the second target interface matching display resolution of the second area; and
display the second target interface in the second area.

11. The device of claim 8, wherein the display module is further configured to:
obtain operation habit data of a user of the electronic apparatus;
in response to the operation habit data being first target data, determine a target area of a first short side of the display screen as the first area;
in response to the operation habit date being second target data, determine a target area of a second short side of the display screen as the first area; and
display the virtual keyboard in the first area.

12. The device of claim 8, wherein the display module is further configured to:
obtaining a view of the virtual keyboard;
adjusting a size of the view of the virtual keyboard according to a resolution of the first area to cause the view of the virtual keyboard to adapt to the first area; and
displaying the view of the virtual keyboard in the first area to cause a display direction of characters in the virtual keyboard to be parallel to a short side of the display screen.

13. The device of claim 8, wherein the display module is further configured to:
in response to the electronic apparatus being switched from the landscape display mode to a portrait display mode, adjust a display direction of the virtual keyboard in the first area to cause a display direction of characters in the virtual keyboard to be switched from being parallel to the short side of the display output area of the display screen to being perpendicular to the short side of the display output area of the display screen.

14. The device of claim 13, wherein the display module is further configured to:
rotate the virtual keyboard in the first area to cause the display direction of the characters in the virtual keyboard to be switched from being parallel to the short side of the display output area of the display screen to being perpendicular to the short side of the display output area of the display screen; or
stop displaying the virtual keyboard;
obtain the view of the virtual keyboard;
adjust a size of the view of the virtual keyboard according to a resolution of the first area to cause the view of the virtual keyboard to adapt to the first area; and
display the view of the virtual keyboard in the first area to cause the display direction of the characters in the virtual keyboard to be perpendicular to the short side of the display output area of the display screen.

15. An electronic apparatus, comprising:
a processor; and
a memory storing a program that, when executed by the processor, causes the processor to:
obtain an information input instruction;
in response to the information input instruction, obtain attitude information of an electronic apparatus; and
in response to the attitude information indicating that the electronic apparatus is in a landscape display mode, display a virtual keyboard in a first area of a display screen of the electronic apparatus;
wherein the first area corresponds to a short side of a display output area of the display screen, and the first area includes a part of the display output area of the display screen.

16. The apparatus of claim 15, wherein the processor is further caused to:
in response to the electronic apparatus being in the landscape display mode, display a first target interface of a first application in the display output area adapting to the landscape display mode;
display the virtual keyboard in the first area, the virtual keyboard covering a first portion of the first target interface located in the first area; or
when the virtual keyboard is displayed in the first area, display a second target interface of the first application in a second area of the display screen adapting to the landscape display mode.

17. The device of claim 16, wherein the processor is further caused to:
obtain the second target interface matching display resolution of the second area; and
display the second target interface in the second area.

18. The device of claim 15, wherein the processor is further caused to:
obtain operation habit data of a user of the electronic apparatus;
in response to the operation habit data being first target data, determine a target area of a first short side of the display screen as the first area;
in response to the operation habit date being second target data, determine a target area of a second short side of the display screen as the first area; and
display the virtual keyboard in the first area.

19. The device of claim 15, wherein the processor is further caused to:
obtain a view of the virtual keyboard;
adjust a size of the view of the virtual keyboard according to a resolution of the first area to cause the view of the virtual keyboard to adapt to the first area; and
display the view of the virtual keyboard in the first area to cause a display direction of characters in the virtual keyboard to be parallel to a short side of the display screen.
